(19) United States
(12) Patent Application Publication
(10) Pub. No.: US 2026/0070798 A1
(43) Pub. Date: Mar. 12, 2026

(54) PROCESS AND DEVICE FOR PREPARING ULTRA-CLEAN HIGH-PURITY AMMONIA WATER

(71) Applicant: Jiangsu Meiyang Electronic Chemicals Co., LTD, Suzhou (CN)

(72) Inventor: Xiangqing Li, Suzhou (CN)

(21) Appl. No.: 19/319,793

(22) Filed: Sep. 5, 2025

(30) Foreign Application Priority Data
Sep. 6, 2024 (CN) 2024112500948

(51) Int. Cl. C01C 1/02; B01D 53/04; B01D 53/14; B01D 61/14; B01D 69/02; B01D 71/34; B01J 20/10; B01J 20/28; B01J 20/30

(52) U.S. Cl. CPC C01C 1/022; B01D 53/0423; B01D 53/1493; B01D 61/145; B01D 69/02; B01D 71/34; B01J 20/103; B01J 20/28061; B01J 20/2808; B01J 20/28085; B01J 20/3078; B01J 20/3085; C01C 1/024; B01D 2252/103; B01D 2253/116; B01D 2253/306; B01D 2253/308; B01D 2325/02833; C01P 2006/80

(57) ABSTRACT

A process and a device for preparing ultra-clean high-purify ammonia water are provided. The ultra-pure high-purity ammonia water is obtained by heating and gasifying, pressurizing to remove impurities, washing with ultrapure water to remove impurities, purifying with a molecular sieve adsorption column, absorbing with ultrapure water and filtering with an ultrafiltration membrane. The obtained ultra-pure high-purity ammonia water has high product quality and simple process. The obtained ultra-pure high-purity ammonia water has lower contents of metals and particles, the process is safe and reliable, and has low energy consumption. The process has no waste discharge, and is environmentally friendly and practical.

### CROSS-REFERENCE TO RELATED APPLICATION

This application claims priority to Chinese Patent Application No. 202411250094.8, filed on Sep. 6, 2024, which is herein incorporated by reference in its entirety.

### TECHNICAL FIELD

The disclosure relates to the field of electronic grade chemical preparation technologies, and more particularly to a process and a device for preparing ultra-clean high-purity ammonia water.

### BACKGROUND

With the rapid development of technology in the semiconductor industry, the requirements and standards for purity of ultra-clean and high-purity reagents have been continuously improved. Electronic grade ammonia water has been widely used, and its preparation process has also been paid more and more attention.

During the production, transportation and storage of the ammonia water, due to reasons with raw materials and equipment, some metal ions, dust particles, unreacted raw materials and intermediate products are inevitably brought into the product, and these impurities can easily lead to the formation of staggered layers, resulting in breakdown. For ultra-precision integrated circuits, very few metal ions as well as particles can damage the entire circuit. Therefore, how to effectively remove metal ions and dust particles is a technical problem to be solved urgently.

A Chinese patent application with a publication No. CN102275951A discloses a method for producing ultrapure ammonia water. In this method, liquid ammonia is gasified to obtain ammonia gas, and the ammonia gas is introduced into an ultrasonic purification tower. An ultrasonic atomizer is disposed on a lower part of the ultrasonic purification tower. Ultrapure water is contained in the ultrasonic atomizer. The ultrasonic atomizer generates fine ammonia water particles. The impurities in the ammonia gas are adsorbed by the fine ammonia water particles to obtain purified ammonia gas. The obtained purified ammonia gas is filtered by a filter and then input into a product absorption tower. The ammonia gas is combined with the ultrapure water in the product absorption tower to obtain ultrapure ammonia water. The process requires the use of the ultrasonic purification tower, and the efficiency of impurity removal is not high.

A Chinese patent application with a publication No. CN105523570A discloses a method for preparing parts per trillion (PPT) grade ultrapure ammonia water, including the steps below which are performed sequentially and continuously: (1) gasification, including: evaporating ammonia water with hot steam into ammonia gas; (2) purification filtration, including: purifying the ammonia gas by sequentially passing through a drainage separator and an active carbon adsorber to obtain purified ammonia gas; (3) resin adsorption, including: performing adsorption and degreasing treatment on the purified ammonia gas by the adsorption resin; (4) washing, including: washing the ammonia gas adsorbed by the resin with ultrapure water and saturated ammonia water to remove impurities; (5) water-gas separation, including: separating the washed ammonia gas into water gas and ammonia gas by a water-gas separator; (6) multi-stage absorption, including: performing multi-stage absorption on the ammonia gas with ultrapure water through an absorption tower to form ammonia water; (7) ultrafiltration, including: performing ultrafiltration treatment on the ammonia water to obtain the PPT grade ultrapure ammonia water. The process steps are tedious, and the purity and quality of the product obtained are poor.

Overall, in the preparation processes disclosed in the related art, the removal efficiency of impurity metals and particles is relatively low and the process is relatively complicated, which cannot meet the requirements for the production of high-grade electronic-grade ammonia water and large-scale production.

### SUMMARY

The disclosure provides a process and a device for preparing ultra-clean high-purity ammonia water, which aims to provide a new and efficient method for reducing the content of impurities such as metals and particles in electronic-grade ammonia water and improving the quality of electronic-grade ammonia water.

An objective of the disclosure is to overcome disadvantages in the related art, to provide a process and a device for preparing ultra-clean high-purity ammonia water. In order to achieve the above technical objective, technical solutions adopted by the disclosure are as follows.

A process for preparing ultra-clean high-purity ammonia water includes:
(1) performing heating gasification, comprising: heating industrial grade ammonia water to evaporate into ammonia gas;
(2) pressurizing the ammonia gas to remove impurities, comprising: pressurizing the ammonia gas obtained in step (1) to deposit organic impurifies, impurity metals, and particles existing in the ammonia gas to obtain pressurized ammonia gas;
(3) washing the pressurized ammonia gas with ultrapure water to remove impurities, comprising: cooling the pressurized ammonia gas obtained in step (2) through a cooling tower to obtain cooled ammonia gas, and transporting the cooling ammonia gas to a washing tower containing the ultrapure water to obtain ammonia water; and releasing high-purity ammonia gas from the washing tower when the ammonia water in the washing tower reaches saturation;
(4) purifying the high-purity ammonia gas with a molecular sieve column, comprising: purifying the high-purity ammonia gas obtained in step (3) through an adsorption column filled with a molecular sieve to obtain purified ammonia gas;
(5) absorbing the purified ammonia gas obtained in step (4) with the ultrapure water to obtain a product; and
(6) filtering the product obtained in step (5) with an ultrafiltration membrane to obtain the ultra-clean high-purity ammonia water.

In an embodiment, in step (1), a temperature of the heating is 50 Celsius degrees (° C.).

In an embodiment, in the step (2), a pressure is in a range of 0.3 megapascals (MPa) to 0.6 MPa, and a temperature is 15° C. The pressurizing the ammonia gas to remove impurities can deposit organic impurities and metals complexed therewith, and thus can effectively reduce the content of the organic impurities and metal ions.

In an embodiment, in the step (4), a macroporous-microporous molecular sieve is filled in the adsorption column.

In an embodiment, a pore diameter of each macropore is in a range of 100 nanometers (nm) to 500 nm, a pore diameter of each micropore is in a range of 0.3 nm to 0.7 nm, and a specific surface area of the molecular sieve is in a range of 140 square meters per gram (m²/g) to 500 m²/g.

A process for preparing the macroporous-microporous molecular sieve includes: mixing anhydrous ethanol and deionized water evenly at room temperature (20° C.) to obtain a mixed solution, adding ammonia water into the mixed solution, and stirring the mixed solution added with the ammonia water to obtain a stirred solution; adding tetraethyl orthosilicate dropwise into the stirred solution, and stirring the stirred solution added with the tetraethyl orthosilicate, followed by centrifuging and drying, to obtain silica microspheres; dispersing the silica microspheres in a mixed solution of a tetrapropylammonium hydroxide aqueous solution and anhydrous ethanol to obtain a dispersed solution, and performing ultrasound on the dispersed solution to obtain a mixed raw material; drying the mixed raw material to obtain a dry glue; and transferring the dry glue into a reactor with deionized water in a bottom, crystallizing the dry glue with steam assistance to obtain a crystallized dry glue, and taking out the crystallized dry glue, followed by washing, drying, and calcining in an air atmosphere, to obtain the macroporous-microporous molecular sieve.

In an embodiment, a volume ratio between the anhydrous ethanol to the deionized water is in a range of 10:1 to 1:1.

In an embodiment, a molar ratio between the silica microspheres to the tetrapropylammonium hydroxide is in a range of 1:0.1 to 1:0.5.

In an embodiment, the drying the mixed raw material is gradient drying, including: drying at 40° C. for 6 hours (h), and drying at 60° C. for 2 h.

In an embodiment, a temperature of the calcining is in a range of 400° C. to 600° C. In an embodiment, the temperature of the calcining is in a range of 500° C. to 560° C.

The macroporous-microporous molecular sieve is used without introducing other impurities. At the same time, through the synergistic effect of macroporous and microporous, it can more effectively adsorb ultrafine particles, metals, various ionic organic impurities, and improve product purity.

In an embodiment, in the step (6), the ultrafiltration membrane is a polymer ultrafiltration membrane.

In an embodiment, the ultrafiltration membrane is a fluorinated polymer ultrafiltration membrane.

In an embodiment, the ultrafiltration membrane is a polyvinylidene fluoride (PVDF) ultrafiltration membrane. In an embodiment, a pore diameter of the PVDF ultrafiltration membrane is in a range of 0.03 micron (μm) to 0.1 μm.

Compared with the related art, the disclosure has the following advantages and beneficial effects.

(1) The ultra-clean high-purity ammonia water produced by the process and device used in the disclosure has high yield and stable product quality, which is convenient for industrial production, and has strong practicality.

(2) The number of times of distillation is reduced, no special device is used, and the energy consumption is reduced. The separation process is simple without generating additional environmental pollution issues, which is environment-friendly and practical.

(3) The pressurization deposition method can deposit the organic impurities, and metals complexed therewith, and thus can effectively reduce the content of the organic impurities and metal ions.

(4) The adsorption columns filled with the macroporous-microporous molecular sieve is used, through the synergistic effect of macroporous and microporous, it effectively reduces the content of particles and metal ions, and improves the quality grade of ultra-clean high-purity ammonia water.

### BRIEF DESCRIPTION OF DRAWING

FIGURE illustrates a schematic diagram of a device for preparing ultra-clean high-purity ammonia water according to the disclosure.

### DESCRIPTION OF REFERENCE SIGNS

1—evaporator; 2—pressurized tank; 3—cooling tower; 4—washing tower; 5—adsorption column; 6—absorption tower; 7—ultrafiltration membrane filter; 8—collecting tank.

### DETAILED DESCRIPTION OF EMBODIMENTS

The following embodiments are merely illustrative of the disclosure and are not to be construed as limiting a scope of the disclosure in any way.

### Embodiment 1

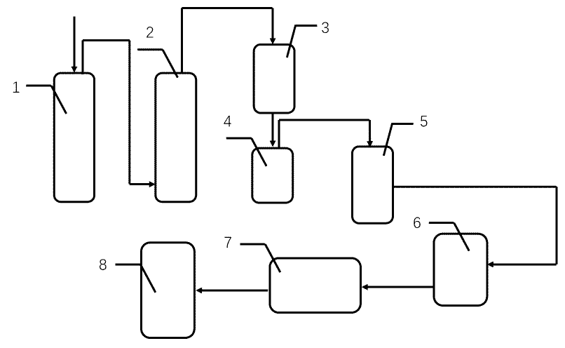

A process for preparing ultra-clean high-purity ammonia water is achieved by adopting a device as shown in FIG. 1.

Specifically, industrial grade ammonia water is transported from a raw material tank into an evaporator 1 to be heated at 50° C., and evaporated to ammonia gas. The ammonia gas is transported into a pressurized tank 2 to be pressurized with a pressure of 0.3 MPa and a temperature of 15° C. for 30 minutes (min), to thereby obtain pressurized ammonia gas. The pressurized ammonia gas passes through a cooling tower 3 and enters a washing tower 4 containing ultrapure water, and washed ammonia gas is released when the ammonia water in the washing tower 4 reaches saturation. The washed ammonia gas enters an adsorption column 5 filled with a molecular sieve to be purified to obtain purified ammonia gas. The purified ammonia gas enters an absorption tower 6, and is absorbed with the ultrapure water to obtain ammonia water. Finally, the ammonia water is filtered through an ultrafiltration membrane filter 7 under a pressure of 1 MPa to obtain the ultra-clean high-purity ammonia water. Then, the ultra-clean high-purity ammonia water enters a collecting tank 8.

A process for preparing the above molecular sieve is as follows. 100 milliliters (mL) of anhydrous ethanol and 100 mL of deionized water are mixed evenly at the room temperature (20° C.) to obtain a mixed solution, 30 mL of ammonia water is added into the mixed solution, and the mixed solution added with the ammonia water is stirred for 30 min to obtain a stirred solution. 65 mL of tetraethyl orthosilicate is added dropwise into the stirred solution, and the stirred solution added with the tetraethyl orthosilicate is stirred for 6 h, centrifugated and dried to obtain silica microspheres. A particle size each silica microsphere is about 520 nm.

5 grams (g) of the silica microspheres is dispersed in a mixed solution of a tetrapropylammonium hydroxide aqueous solution (2 moles per liter, abbreviated as M) and 20 mL of anhydrous ethanol to obtain a dispersed solution, and a molar ratio between tetrapropylammonium hydroxide to the silica microspheres is 0.15. Ultrasound is performed on the dispersed solution for 1 h to obtain a mixed raw material. The mixed raw material is dried at 40° C. for 6 h, and dried at 60° C. for 2 h to obtain a dry glue. The dry glue is transferred into a reactor with an appropriate amount of deionized water in a bottom, the dry glue is crystallized with steam assistance at 180° C. for 24 h to obtain a crystallized dry glue. The crystallized dry glue is taken out, washed, dried and calcined at 560° C. for 8 h in an air atmosphere, to obtain a macroporous-microporous molecular sieve. A specific surface area of the obtained molecular sieve is 370 m²/g, a total pore volume is 0.25 cubic centimeters per gram (cm³/g), a pore diameter of each macropore is in a range of 150 nm to 500 nm, and a pore diameter of each micropore is in a range of 0.3 nm to 0.7 nm.

For pore volume calculation, a conventional mercury porosity method in the art is used to evaluate a volume of the macropores, and a nitrogen physical adsorption method is used to test a volume of the micropores and the macropores.

The adopted ultrafiltration membrane is a PVDF ultrafiltration membrane with a pore diameter of 0.1 μm.

### Embodiment 2

A process for preparing ultra-clean high-purity ammonia water is achieved by adopting a device as shown in FIG. 1.

Specifically, the industrial grade ammonia water is transported from the raw material tank into the evaporator 1 through a compressor and evaporated by using hot steam to ammonia gas. The ammonia gas is transported into the pressurized tank 2 to be pressurized with a pressure of 0.3 MPa and a temperature of 15° C., to thereby obtain pressurized ammonia gas. The pressurized ammonia gas passes through the cooling tower 3 and enters the washing tower 4 containing ultrapure water, and washed ammonia gas is released when the ammonia water in the washing tower 4 reaches saturation. The washed ammonia gas enters the adsorption column 5 filled with the molecular sieve to be purified to obtain purified ammonia gas. The purified ammonia gas enters the absorption tower 6, and is absorbed with the ultrapure water to obtain ammonia water. Finally, the ammonia water is filtered through the ultrafiltration membrane filter 7 under a pressure of 1 MPa to obtain the ultra-clean high-purity ammonia water. Then the ultra-clean high-purity ammonia water enters the collecting tank 8.

A process for preparing the above molecular sieve is as follows. 100 mL of anhydrous ethanol and 50 mL of deionized water are mixed evenly at the room temperature (20° C.) to obtain a mixed solution, 30 mL of ammonia water is added into the mixed solution, and the mixed solution added with the ammonia water is stirred for 30 min to obtain a stirred solution. 65 mL of tetraethyl orthosilicate is added dropwise into the stirred solution, and the stirred solution added with the tetraethyl orthosilicate is stirred for 6 h, centrifugated and dried to obtain silica microspheres. A particle size each silica microsphere is about 520 nm.

5 g of the silica microspheres is dispersed in a mixed solution of a tetrapropylammonium hydroxide aqueous solution (2 M) and 20 mL of anhydrous ethanol to obtain a dispersed solution, and a molar ratio between tetrapropylammonium hydroxide to the silica microspheres is 0.15. Ultrasound is performed on the dispersed solution for 1 h to obtain a mixed raw material. The mixed raw material is dried at 40° C. for 6 h, and dried at 60° C. for 2 h to obtain a dry glue. The dry glue is transferred into the reactor with an appropriate amount of deionized water in a bottom, the dry glue is crystallized with steam assistance at 180° C. for 18 h to obtain a crystallized dry glue. The crystallized dry glue is taken out, washed, dried and calcined at 550° C. for 8 h in an air atmosphere, to obtain a macroporous-microporous molecular sieve. A specific surface area of the obtained molecular sieve is 392 m²/g, a total pore volume is 0.28 cm³/g, a pore diameter of each macropore is in a range of 150 nm to 400 nm, and a pore diameter of each micropore is in a range of 0.3 nm to 0.6 nm.

For pore volume calculation, a conventional mercury porosity method in the art is used to evaluate a volume of the macropores, and a nitrogen physical adsorption method is used to test a volume of the micropores and the macropores.

The adopted ultrafiltration membrane is a PVDF ultrafiltration membrane with a pore diameter of 0.1 μm.

### Embodiment 3

A process for preparing ultra-clean high-purity ammonia water is achieved by adopting a device as shown in FIG. 1.

Specifically, the industrial grade ammonia water is transported from the raw material tank into the evaporator 1 through the compressor, and evaporated by using hot steam to ammonia gas. The ammonia gas is transported into the pressurized tank 2 to be pressurized with a pressure of 0.5 MPa and a temperature of 20° C., to thereby obtain pressurized ammonia gas. The pressurized ammonia gas passes through the cooling tower 3 and enters the washing tower 4 containing ultrapure water, and washed ammonia gas is released when the ammonia water in the washing tower 4 reaches saturation. The washed ammonia gas enters the adsorption column 5 filled with the molecular sieve to be purified to obtain purified ammonia gas. The purified ammonia gas enters the absorption tower 6, and is absorbed with the ultrapure water to obtain ammonia water. Finally, the ammonia water is filtered through the ultrafiltration membrane filter 7 under a pressure of 1 MPa to obtain the ultra-clean high-purity ammonia water. Then the ultra-clean high-purity ammonia water enters the collecting tank 8.

The materials used for the adsorption filled with the molecular sieve and the PVDF ultrafiltration membrane are the same as that of the embodiment 1.

### Comparative Embodiment 1

A process for preparing ultra-clean high-purity ammonia water is achieved by adopting a device similar to a device as shown in FIG. 1, which omits the pressurized tank 2 and corresponding steps.

Specifically, the industrial grade ammonia water is transported from the raw material tank into the evaporator 1 through the compressor, and evaporated by using hot steam to ammonia gas. The ammonia gas passes through the cooling tower 3 and enters the washing tower 4 containing ultrapure water, and washed ammonia gas is released when the ammonia water in the washing tower 4 reaches saturation. The washed ammonia gas enters the adsorption column 5 filled with the molecular sieve to be purified to obtain purified ammonia gas. The purified ammonia gas enters the absorption tower 6, and is absorbed with the ultrapure water to obtain ammonia water. Finally, the ammonia water is filtered through the ultrafiltration membrane filter 7 under a pressure of 1 MPa to obtain the ultra-clean high-purity ammonia water. Then the ultra-clean high-purity ammonia water enters the collecting tank 8.

The materials used for the adsorption filled with the molecular sieve and the PVDF ultrafiltration membrane are the same as that of the embodiment 1.

### Comparative Embodiment 2

A process for preparing ultra-clean high-purity ammonia water is achieved by adopting a device as shown in FIG. 1.

Specifically, the industrial grade ammonia water is transported from the raw material tank into the evaporator 1 through the compressor, and evaporated by using hot steam to ammonia gas. The ammonia gas is transported into the pressurized tank 2 to be pressurized with a pressure of 0.3 MPa and a temperature of 15° C., to thereby obtain pressurized ammonia gas. The pressurized ammonia gas passes through the cooling tower 3 and enters the washing tower 4 containing ultrapure water, and washed ammonia gas is released when the ammonia water in the washing tower 4 reaches saturation. The washed ammonia gas enters the adsorption column 5 filled with the molecular sieve to be purified to obtain purified ammonia gas. The purified ammonia gas enters the absorption tower 6, and is absorbed with the ultrapure water to obtain ammonia water. Finally, the ammonia water is filtered through the ultrafiltration membrane filter 7 under a pressure of 1 MPa to obtain the ultra-clean high-purity ammonia water. Then the ultra-clean high-purity ammonia water enters the collecting tank 8.

The molecular sieve used is an existing microporous molecular sieve zeolite Socony Mobil® 22 (ZSM-22).

The adopted ultrafiltration membrane is a PVDF ultrafiltration membrane with a pore diameter of 0.1 μm.

### Measuring Method:

Measurement of metal ion mass fraction is as follows. An inductively coupled plasma-mass spectrometry (ICP-MS), such as Agilent® 7700sICP-MS, is used for measurement. 5 g of sample (i.e., the ultra-clean high-purity ammonia water) of each embodiment and comparative embodiment is weighed to the nearest 0.01 g, and slowly placed into a 50 mL volumetric flask containing a small amount of ultrapure water to obtain a mixed solution. The mixed solution is cooled to the room temperature, diluted with water to the mark, and shaken evenly. The signal intensity of each element in the sample is measured under the same analysis conditions as the standard solution series, and a blank test is conducted at the same time.

Measurement of particles is as follows. A laser liquid particle counter is used for measurement.

Specific measuring data is shown in Table 1.

| | | | | Comparative | Comparative |
|---|---|---|---|---|---|
| Item | Embodiment 1 | Embodiment 2 | Embodiment 3 | embodiment 1 | embodiment 2 |
| Ammonia water | 29.5% | 29.6% | 29.6% | 28.8% | 28.7% |
| concentration (%) | | | | | |
| Aluminum/(parts | 0.08 | 0.08 | 0.08 | 2 | 4.2 |
| per billion | | | | | |
| abbreviated as ppb) | | | | | |
| Arsenic/(ppb) | 0.13 | 0.13 | 0.13 | 0.8 | 0.8 |
| Boron/(ppb) | 0.16 | 0.16 | 0.16 | 1.8 | 2.3 |
| Calcium/(ppb) | 0.16 | 0.15 | 0.16 | 2.8 | 2.2 |
| Chromium/(ppb) | 0.15 | 0.15 | 0.15 | 0.16 | 0.18 |
| Copper/(ppb) | 0.16 | 0.17 | 0.17 | 1.3 | 1.3 |
| Iron/(ppb) | 0.18 | 0.17 | 0.17 | 1.1 | 1.4 |
| Lithium/(ppb) | 0.14 | 0.13 | 0.14 | 0.6 | 0.7 |
| Magnesium/(ppb) | 0.15 | 0.14 | 0.14 | 0.8 | 1.1 |
| Potassium/(ppb) | 0.13 | 0.13 | 0.13 | 3.3 | 3.4 |
| Silver/(ppb) | 0.14 | 0.14 | 0.14 | 0.16 | 0.18 |
| Sodium/(ppb) | 0.16 | 0.16 | 0.14 | 3.6 | 2.6 |
| Titanium/(ppb) | 0.14 | 0.17 | 0.16 | 1.5 | 1.4 |
| Zinc/(ppb) | 0.08 | 0.08 | 0.08 | 0.19 | 0.19 |
| Particle ≥0.2 | ≤2 | ≤2 | ≤2 | ≥10 | ≥8 |
| μm/(per/mL) | | | | | |

The above embodiments and measuring data are only a few applications and embodiments of the disclosure and do not limit the scope of protection of the disclosure. From the above description, it can be seen by those skilled in the art that the disclosure has been made by way of novel concepts and means, and thus has obvious practicality and inventive steps.

What is claimed is:

1. A process for preparing ultra-clean high-purity ammonia water, comprising:
(1) performing heating gasification, comprising: heating industrial grade ammonia water to evaporate into ammonia gas;
(2) pressurizing the ammonia gas to remove impurities, comprising: pressurizing the ammonia gas obtained in step (1) to deposit organic impurifies, impurity metals, and particles existing in the ammonia gas to obtain pressurized ammonia gas;
(3) washing the pressurized ammonia gas with ultrapure water to remove impurities, comprising: cooling the pressurized ammonia gas obtained in step (2) through a cooling tower to obtain cooled ammonia gas, and transporting the cooling ammonia gas to a washing tower containing ultrapure water to obtain ammonia water; and releasing high-purity ammonia gas from the washing tower when the ammonia water in the washing tower reaches saturation;
(4) purifying the high-purity ammonia gas with a molecular sieve column, comprising: purifying the high-purity ammonia gas obtained in step (3) through an adsorption column filled with a molecular sieve to obtain purified ammonia gas;
(5) absorbing the purified ammonia gas obtained in step (4) with the ultrapure water to obtain a product; and
(6) filtering the product obtained in step (5) with an ultrafiltration membrane to obtain the ultra-clean high-purity ammonia water;
wherein, in the step (2), conditions of the pressurizing comprise: a pressure of 0.3 megapascals (MPa) to 0.6 MPa, and a temperature of 10 Celsius degrees (° C.) to 20° C.; and
wherein, in the step (4), the molecular sieve is a macroporous-microporous molecular sieve; a pore diameter of each macropore is in a range of 100 nanometers (nm) to 500 nm, a pore diameter of each micropore is in a range of 0.3 nm to 0.7 nm, and a specific surface area of the molecular sieve is in a range of 140 square meters per gram (m²/g) to 500 m²/g; and a process for preparing the molecular sieve comprises: mixing anhydrous ethanol and deionized water evenly at room temperature to obtain a mixed solution, adding ammonia water into the mixed solution, and stirring the mixed solution added with the ammonia water to obtain a stirred solution; adding tetraethyl orthosilicate dropwise into the stirred solution, and stirring the stirred solution added with the tetraethyl orthosilicate, followed by centrifuging and drying, to obtain silica microspheres; dispersing the silica microspheres in a mixed solution of a tetrapropylammonium hydroxide aqueous solution and anhydrous ethanol to obtain a dispersed solution, and performing ultrasound on the dispersed solution to obtain a mixed raw material; drying the mixed raw material to obtain a dry glue; and transferring the dry glue into a reactor with deionized water in a bottom, crystallizing the dry glue with steam assistance to obtain a crystallized dry glue, and taking out the crystallized dry glue, followed by washing, drying, and calcining in an air atmosphere, to obtain the macroporous-microporous molecular sieve.

2. The process as claimed in claim 1, wherein the drying the mixed raw material is gradient drying, comprising: drying at 40° C. for 6 hours (h), and drying at 60° C. for 2 h; and a temperature of the calcining is 560° C.

3. The process as claimed in claim 1, wherein the ultrafiltration membrane is a polymer ultrafiltration membrane.

4. The process as claimed in claim 3, wherein the ultrafiltration membrane is a fluorinated polymer ultrafiltration membrane.

5. The process as claimed in claim 4, wherein the ultrafiltration membrane is a polyvinylidene fluoride (PVDF) ultrafiltration membrane with a pore diameter of 0.1 micron (μm).
